(19) United States
(12) Patent Application Publication
(10) Pub. No.: US 2026/0330065 A1
(43) Pub. Date: Oct. 22, 2026

(54) SYSTEMS AND METHODS FOR CONIFRMING DATA INTEGRITY OF A PROTECTED DATASET REPRESENTING A PLURALITY OF PROTECTED NETWORK OPERATIONS TO BE EXECUTED BY A CLASSIFICATION MODEL TO UPDATE AT LEAST A PORTION OF THE CLASSIFICATION MODEL

(71) Applicant: Capital One Services, LLC, McLean, VA (US)

(72) Inventors: Zakery FYKE, Waco, TX (US); Jamie WATERS, Mckinney, TX (US); Shailendra MAKTEDAR, Argyle, TX (US); Jonathan LAY, McKinney, TX (US)

(73) Assignee: Capital One Services, LLC, McLean, VA (US)

(21) Appl. No.: 19/182,578

(22) Filed: Apr. 17, 2025

(51) Int. Cl. G06F 21/64; G06N 3/08

(52) U.S. Cl. CPC G06F 21/64; G06N 3/08

(57) ABSTRACT

Systems and methods for confirming data integrity of a dataset representing a plurality of network operations to be executed by a classification model to update at least a portion of the model are disclosed. For example, a system can be configured to obtaining training data associated with a dataset of network operations to be executed by a classification model to update one or more parameters of the model. The system can analyze the dataset to determine one or more compatibility indicators that each indicate a degree to which the dataset obtained is compatible with one or more machine learning models to be trained or updated. The system can then validate the dataset based on the first compatibility indicator and the second compatibility indicator and provide a third indicator to prevent a computing device from executing operations to update the one or more parameters based on the intermediate indication.

### BACKGROUND

In certain scenarios, the compatibility and performance of a machine learning model can be evaluated by analyzing outputs generated by the model. For example, a dataset can be established through processes such as data aggregation where relevant data is collected and combined from various sources. Once prepared, the dataset can be input into the model to cause the model to generate outputs such as predictions or classifications. The outputs can then be evaluated to assess the performance and compatibility of the model when using the dataset. This evaluation can include determining metrics such as accuracy (measuring the overall correctness of the outputs of the model), precision (the proportion of positive identifications that were correct), recall (the proportion of actual positive cases that were correctly identified), and so on.

However, this approach can lead to several technical disadvantages. First, if some or all of the data from the dataset is incompatible with the model, resources such as processing resources, memory, and in some instances communication network capacity can be wasted training or updating the model, as the model will need to be retrained to attain meaningful performance or correct for errors introduced by the dataset (if correctable at all). Further, poor-quality, or noisy data (such as mislabeled entries, ambiguous features, etc.) can exacerbate inefficiencies by misleading the training process and increasing computational overhead without yielding meaningful insights. In instances where the model is trained on temporally irrelevant data, the model may fail to adapt to current patterns in the production environment, leading to reduced predictive accuracy and degraded performance, especially as the underlying data distribution evolves.

### SUMMARY

In view of these challenges, systems and methods are described herein relating to novel uses and/or improvements when confirming data integrity of a protected dataset representing a plurality of protected network operations to be executed by a classification model to update at least a portion of the classification model. By implementing the techniques described herein to evaluate datasets as part of a model training workflow, significant technical advantages are realized that result in reduced computing resource consumption, including reduced processing and memory consumption. First, by determining whether a dataset is compatible with a model before executing at least some of the operations involved in training and/or updating the model, systems can minimize unnecessary computational overhead and resource allocation that would otherwise be directed to training the model just to determine that the data itself, and not necessarily the model, is the cause of suboptimal model performance. This can lead to substantial reductions in processor utilization and memory consumption, as incompatible datasets are identified and filtered out before initiating a resource-intensive training process. In some examples where the system can update the dataset to improve dataset compatibility with the model being trained or updated, the techniques described can improve or optimize memory usage by selectively loading only compatible data segments, reducing the overall memory footprint required for model training. Additionally, these techniques can significantly improve network efficiency by minimizing the transfer of irrelevant or incompatible data, thereby reducing network communication overhead.

In some aspects, systems, and methods for confirming data integrity of a protected dataset representing a plurality of protected network operations to be executed by a classification model to update at least a portion of the classification model are described. For example, a system can obtain training data associated with a dataset to be executed by a machine learning model (e.g., a classification model, etc.) to update one or more parameters of the machine learning model. In this example, the system can determine a first compatibility indicator based on a comparison of one or more first aspects of the dataset to first predetermined criteria, and a second compatibility indicator based on a comparison of one or more second aspects of the dataset to second predetermined criteria. The first compatibility indicator can be associated with a first indication of whether the dataset is compatible with the machine learning model, and the second compatibility indicator can be associated with a second indication of whether the dataset is compatible with the machine learning model. In some examples, the system can validate the dataset to determine an intermediate indication of at least a degree to which the dataset is compatible with the machine learning model based on the first compatibility indicator and the second compatibility indicator. And in some examples, the system can provide a third indicator to control operation of a computing device involved in updating the one or more parameters of the machine learning model based on the intermediate indication.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows a diagram of an environment for confirming data integrity of a protected dataset representing a plurality of protected network operations to be executed by a classification model to update at least a portion of the classification model, in accordance with one or more embodiments.

FIG. 2 shows a flow diagram of a process for confirming data integrity of a dataset representing a plurality of network operations to be executed by a model, in accordance with one or more embodiments.

FIG. 3 shows an implementation diagram of a process for confirming data integrity of a dataset representing a plurality of network operations to be executed by a model, in accordance with one or more embodiments.

FIG. 4 shows an implementation diagram of a process for confirming data integrity of a dataset representing a plurality of network operations to be executed by a model, in accordance with one or more embodiments.

FIG. 5 shows components for a system used for confirming data integrity of a protected dataset representing a plurality of protected network operations to be executed by a classification model to update at least a portion of the classification model, in accordance with one or more embodiments.

FIG. 6 shows a flowchart of the steps involved in a process for confirming data integrity of a dataset representing a plurality of network operations to be executed by a model, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention can be practiced without these specific details or with an equivalent arrangement. In other cases, well-known structures and devices are shown in block diagram form to avoid unnecessarily obscuring the embodiments of the invention.

Some of the systems and methods described herein can be configured to confirm the data integrity of a protected dataset, which represents multiple protected network operations to be executed by a machine learning model (for example, when training or updating the model). This system can be configured to obtain training data associated with the dataset, which includes a first set of protected network operations compatible with the model and a second set that is at least partially incompatible. The system determines a first compatibility indicator by comparing certain aspects of the dataset to predetermined criteria, indicating that at least one network operation in the second set is incompatible with the classification model. Similarly, a second compatibility indicator is determined based on another set of criteria, also indicating incompatibility. The dataset is then validated based on these indicators to determine an intermediate indication of its compatibility with the machine learning model. Finally, the system provides a third indicator to prevent a computing device from executing operations to update the machine learning model's parameters based on this intermediate indication.

By determining whether a dataset is compatible with a model before executing operations to training or update the model, the systems described herein can minimize unnecessary computational overhead and resource allocation. This can be done selectively (e.g., when the training data is determined to be incompatible) depending on the degree to which the training data is determined to be incompatible with the model or models being trained. As a result, reductions in processor and memory consumption can be realized. And in some examples, systems can execute updates to the incompatible dataset based on these identified incompatibilities to improve dataset compatibility with the model being trained or updated.

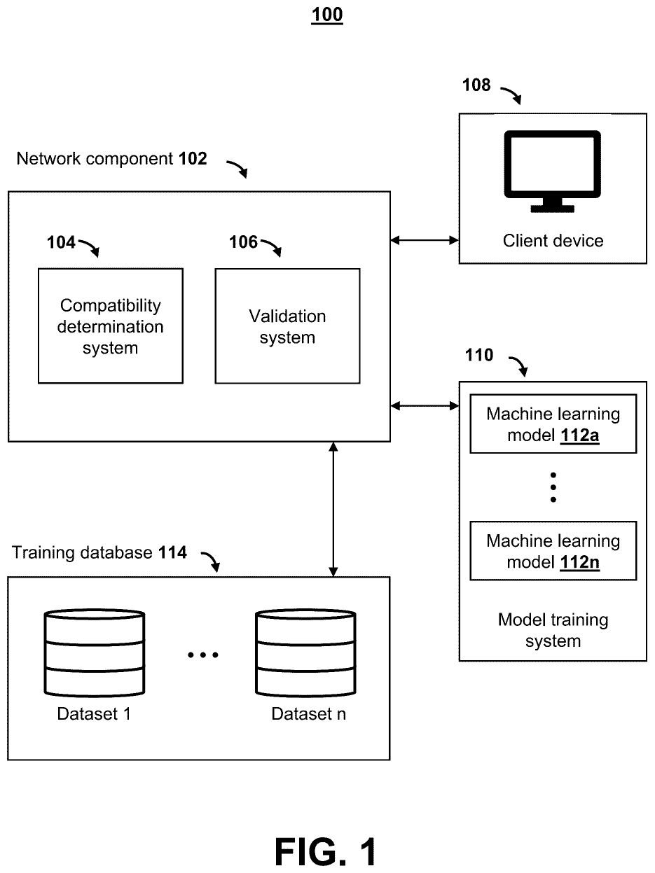

FIG. 1 shows a diagram of a testing environment (referred to as environment 100) that can be configured to, among other things, confirming data integrity of a protected dataset representing a plurality of protected network operations to be executed by a classification model to update at least a portion of the classification model, in accordance with one or more embodiments. For example, the environment 100 can include a network component 102 having one or more components as described herein, a client device 108, a model training system 110, and a training database 114. The network component 102 (e.g., one or more components of the network component 102), the client device 108, the model training system 110, and/or the training database 114 can be configured to interconnect using one or more wired and/or wireless connections. As will be understood, the environment 100 as illustrated includes a network component 102, the client device 108, the model training system 110, and/or the training database 114, but similar environments can include more devices that are the same as, or similar to, those described.

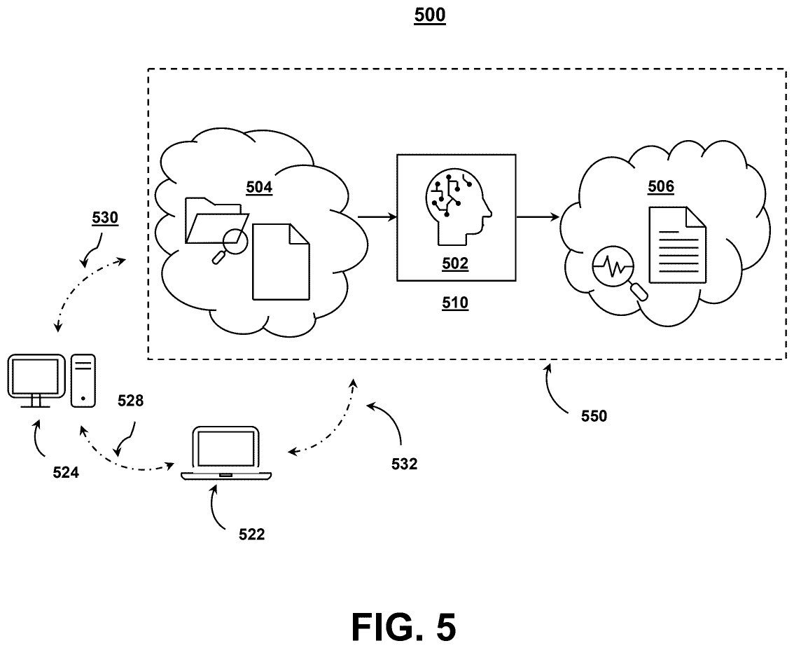

In some embodiments, the network component 102 can include a computing device that is configured to be in communication with the client device 108, the model training system 110, and/or the training database 114 using one or more secured or unsecured communication paths (also referred to as communication connections) as described herein. For example, the network component 102 can include a desktop computer, a laptop computer, a smartphone, a tablet, and/or the like. In some embodiments, the network component 102 can include (e.g., implement) a compatibility determination system 104 and/or a validation system 106. While certain components are illustrated by FIG. 1, the network component 102 can include and/or exclude one or more of the illustrated components. The network component 102 can also include one or more components that are the same as, or similar to, the user terminal 524 of FIG. 5. In some embodiments, the network component 102 can be implemented by one or more other devices of FIG. 1, such as the model training system 110. The network component 102 can be configured to coordinate the analysis and use of datasets stored in the training database during training of the machine learning models 112 as described herein.

In some embodiments, the client device 108 can include a computing device that is configured to be in communication with the network component 102 using one or more communication connections as described herein. For example, the client device 108 can include a desktop computer, a laptop computer, a smartphone, a tablet, and/or the like. In some embodiments, the client device 108 can be involved in (e.g., can direct) the training of one or more machine learning models using a device remote to the client device 108 such as the model training system 110. As described herein, the client device 108 (e.g., one or more components of the network component 102) can establish one or more secured or unsecured communication connections with the network component 102.

In some embodiments, the model training system 110 can include a computing device that is configured to be in communication with the network component 102 using one or more communication connections as described herein. For example, the model training system 110 can include a desktop computer, a laptop computer, a smartphone, a tablet, and/or the like. In some embodiments, the model training system 110 can include (e.g., train and/or implement) machine learning models such as the machine learning models 112a-112n (referred to individually as a machine learning model 112, and collectively as machine learning models 112, as is contextually appropriate). In some embodiments, the machine learning models 112 can include classification models that are involved in receiving data and generating outputs representing one or more classifications. For example, the machine learning models 112 can include classification models that are configured to receive network operation data representing one or more network operations executed within a period of time and generate one or more classifications. These one or more classifications can include classifications that indicate one or more network operations are associated with anomalies, change points, fraudulent payment transactions, non fraudulent payment transactions, etc. While the present disclosure is discussed with respect to the training and/or updating of machine learning models that include classification models, it will be understood that any suitable machine learning model can be implemented by the model training system 110. For example, the model training system 110 can be configured to implement machine learning models 112 such as attention-based models (e.g., transformer models), convolutional neural networks, recurrent neural networks, and/or the like.

In some embodiments, the training database 114 can include a computing device that is configured to be in communication with the network component 102 using one or more communication connections as described herein. For example, the training database 114 can include a desktop computer, a laptop computer, a smartphone, a tablet, and/or the like. In some embodiments, the training database 114 can include (e.g., implement) a one or more datasets that include data usable to train the machine learning models 112 of the model training system 110. For example, the training database 114 can include one or more datasets that store the data in tables, each having one or more rows and one or more columns. In some examples, the training database 114 can include one or more datasets that represent one or more sets of network operations. These network operations can be associated with payment transactions executed over a period of time by one or more devices not explicitly illustrated by FIG. 1.

While certain components are illustrated by FIG. 1, the environment 100, or the various devices thereof, can include and/or exclude one or more of the illustrated components. The environment 100 can also include one or more components that are the same as, or similar to, the devices of FIG. 5. In some embodiments, the devices of the environment 100 can be configured to establish direct or indirect communication connections between one another. For example, one or more networks can establish communication paths between one or more of the devices of the environment 100 to allow for the communication of messages (e.g., network packets, etc.) therebetween. In this example, the communication paths can be the same as, or similar to, the communication paths 528, 530, and 532 of FIG. 5. The network(s) can include mobile phone networks, mobile voice or data networks, cable networks, public switched telephone networks, the Internet, or other types of communications networks or combinations of communications networks as described herein.

It will be understood that the number and arrangement of devices in the environment 100 are provided as an example and that there can be differently arranged environments than those shown in FIG. 1. In some embodiments, at least some of the device(s) and/or system(s) of FIG. 1 can be implemented by a single device or multiple devices within a distributed system. For example, the network component 102 can be implemented by a single device or as multiple devices that, either alone or in coordination, perform one or more of the operations as described herein.

With continued reference to FIG. 1, one or more of the components of the environment 100 can be configured to confirm data integrity of a protected dataset representing a plurality of protected network operations to be executed by a classification model to update at least a portion of the classification model. While the present disclosure discusses the training and/or updating of classification models, it will be understood that any suitable machine learning model can be implemented.

In some embodiments, the network component 102 can be configured to establish a communication connection with the client device 108. For example, the client device 108 can be operated by users such as network administrators, etc. that are involved in the training and/or updating of one or more of the machine learning models 112. In various examples described herein, the network component 102 can be implemented the client device 108 and/or by the model training system 110. In other examples, the network component 102 can be implemented by the model training system 110 or the training database 114 and accessible via the client device 108 establishing one or more communication connections with these devices.

In some embodiments, the network component 102 can obtain training data associated with the datasets stored in the training database 114. The training data can include data to be used to train the machine learning models 112 using the model training system 110. For example, the training data can include one or more datasets that are associated with (e.g., represent) one or more network operations executed within a network such as a payment processing network. In examples, the training data can include protected datasets representing a plurality of protected network operations that are encrypted, etc. The training datasets can be generated based on the execution of network operations within a network environment. For example, the training data can include data that is associated with one or more network operations executed by one or more devices such as point of sale devices, client devices, servers, etc., and representing one or more aspects of the one or more network operations. In some examples, the network operations represented by the dataset can be annotated to indicate that the network operations are associated with anomalies, change points, fraudulent payment transactions, non fraudulent payment transactions, etc.

In some examples, the network component 102 can receive instructions from the client device 108 to cause the network component 102 to obtain at least a portion of the training data associated with the datasets stored in the training database 114. For example, a network administrator or another user can provide input to the client device 108 to be used when configuring the model training system 110 to train and/or update one or more of the machine learning models 112. In this example, the client device 108 can receive the input and provide instructions to the network component 102 based on the input to obtain training data to be used when training or updating the machine learning models 112. Additionally, or alternatively, the client device 108 can establish a communication connection with the model training system 110 and provide some or all of the instructions to the model training system 110. In this example, the model training system 110 can establish a communication connection with the network component 102 to obtain the training data as described herein. The instructions can include an indication of the dataset(s) to be used when training one or more of the machine learning models 112 and can be configured to cause the network component 102 to obtain and provide the one or more datasets from the training database 114 to the model training system 110. The network component 102 can then execute one or more operations to determine the compatibility of the datasets obtained from the training database 114 prior to causing one or more of the machine learning models 112 of the model training system 110 to be executed when training and/or updating the machine learning models 112.

In some embodiments, the network component 102 can execute a compatibility determination system 104. For example, the network component 102 can obtain an indication that the training data obtained from the training database 114 including one or more datasets associated with the training data will be involved in the execution of one or more of the machine learning models 112 to train and/or update the machine learning models 112. The network component 102 can then execute the compatibility determination system 104 to determine one or more compatibility indicators that are indicative of the suitability of a given dataset or set of datasets for the training and/or updating of the machine learning models 112. In examples, the network component 102 can execute the compatibility determination system 104 to determine a first compatibility indicator (e.g., associated with the structure of the data in the datasets) and a second compatibility indicator (e.g., associated with aspects of the elements represented by the data in the datasets), however it will be understood that any suitable number or combination of compatibility indicators can be implemented.

The compatibility determination system 104 can determine the first compatibility indicator based on a comparison of one or more first aspects of the dataset to first predetermined criteria established for the machine learning models 112. For example, the compatibility determination system 104 can determine the first compatibility indicator, where the first compatibility indicator represents an indication (e.g., a first indication) of whether, and to what degree, one or more of the datasets stored in the training database 114 are compatible with one or more of the machine learning models 112. In an example, the compatibility determination system 104 can analyze aspects of the datasets stored in the training database 114 such as schema definitions, column data types, and row value states to determine the degree to which each dataset of the training database 114 obtained by the network component 102 conforms to the parameter types of the parameters that the machine learning models 112. In doing so, the compatibility determination system 104 can identify the presence of, or lack of, data associated with given parameters and/or specific parameter types that the machine learning models 112 are configured to process. For example, the compatibility determination system 104 can identify the presence of, or lack of, null or non-null indicators and compare these characteristics against established parameters of the machine learning models 112 to detect disparities that could impact the performance of the machine learning models 112. As a result, the compatibility determination system 104 can determine that the datasets obtained from the training database 114 are, or are not, compatible (e.g., structurally compatible) with one or more of the machine learning models 112, or are at least partially compatible with one or more of the machine learning models 112. Additionally, or alternatively, the compatibility determination system 104 can determine that one or more additional parameter types are represented by the datasets obtained from the training database 114. In this example, the compatibility determination system 104 can then determine the first compatibility indicator in response to determining that the dataset comprises additional data associated with the additional parameter types that are not required to update the one or more parameters of the machine learning models 112.

In some examples, the compatibility determination system 104 can determine one or more efficiency values representing degrees of efficiency loss that can be attributed to one or more of the datasets obtained from the training database 114. For example, where the training database 114 includes the dataset associated with a number of parameters that is less than the number of parameters to be involved in training one or more of the machine learning models 112, the compatibility determination system 104 can determine a first efficiency value indicating a degree of efficiency loss that is attributable to the lack of data in the datasets obtained from the training database 114. This can represent, for example, whether or not the machine learning models 112 will be trained to generate outputs in accordance with acceptable accuracy, precision, recall, etc. In another example, where the training database 114 includes datasets that are associated with a number of parameters that are higher than a number of parameters involved in the training of one or more of the machine learning models 112, the compatibility determination system 104 can determine a second efficiency value that indicates a degree of efficiency loss that is attributable to the larger dataset. This efficiency loss can be attributed to the need for extra memory consumption and/or processing resources involved at each stage of training of the machine learning models 112.

The compatibility determination system 104 can determine the second compatibility indicator based on a comparison of one or more second aspects of the dataset to second predetermined criteria established for training the machine learning models 112 to perform a particular task or set of tasks. For example, the compatibility determination system 104 can determine the second compatibility indicator, where the second compatibility indicator represents an indication (e.g., a second indication) of whether one or more of the datasets stored in the training database 114 are associated with data that is relevant to the training of the machine learning models 112. In an example, the compatibility determination system 104 can analyze aspects represented by the datasets stored in the training database 114 such as operational parameters that are associated with the elements (e.g., network operations, etc.) represented by the data included in the dataset. Examples of operational parameters can include specific points in time when operations were executed (e.g., an exact moment or point in time when a transaction was initiated or processed), a period of time during which network operations like payment transactions were executed relative to a current point in time, specific values such as transaction amounts, locations, and other relevant details that provide context to the operations being analyzed, the status of network resources, the type of the transactions that were executed (e.g., payment transaction, message transmission, etc.), and so on. Based on the second compatibility indicator and one or more aspects of the machine learning models 112 to be trained by the model training system 110 (e.g., the point in time at which the machine learning models 112 are to be trained, the outputs that the machine learning models 112 are configured to generate, etc.), the compatibility determination system 104 can determine that one or more of the datasets obtained from the training database 114 are, or are not, compatible with one or more of the machine learning models 112, or are at least partially compatible with one or more of the machine learning models 112.

In some embodiments, the compatibility determination system 104 can determine one or more types associated with network operations in the dataset(s) obtained from the training database 114. For example, the compatibility determination system 104 can determine one or more types that include payment transactions, network operations that represent messages passed across the network, etc. The compatibility determination system 104 can then determine one or more network operation parameters associated with the one or more types, where these network operation parameters are included in (e.g., represented by) one or more operational parameters. For example, the compatibility determination system 104 can determine one or more network operation parameters such as points in time or periods of time during which the network operations were executed, specific values or ranges of values associated or established by network operations such as transaction values, etc. These network operation parameters can represent values or ranges of values to be satisfied by network operations that are to be used by the model training system 110 when training one or more of the machine learning models 112. In this example, the compatibility determination system 104 can compare the one or more network operation parameters to values associated with the network operations in the dataset. In some examples, the compatibility determination system 104 can also determine the second compatibility indicator based on the comparison of the one or more network operation parameters to the values associated with the network operations in the dataset, where the second compatibility indicator represents a degree to which the dataset is at least in part compatible with the one or more operational parameters.

In some embodiments, the validation system 106 can be executed by the network component 102 based on the compatibility determination system determining the first compatibility indicator, the second compatibility indicator, or one or more different compatibility indicators. For example, the validation system 106 can compare the first compatibility indicator and the second compatibility indicator to determine a degree to which one or more of the datasets and/or one or more portions of the one or more datasets obtained from the training database 114 satisfy the requirements involved in training the machine learning models 112. In some examples the degree can be represented as a binary degree (e.g., no/yes or 0/1) or a percentage that indicates whether or not one or more of the datasets and/or one or more of the network operations represented by the datasets obtained by the training database 114 satisfy the training goals as described herein for one or more of the machine learning models 112. The validation system 106 can then determine an intermediate indication of a degree according to which the dataset or datasets obtained from the training database 114 are, or are not, compatible with one or more of the machine learning models 112 to be trained by the model training system 110. This intermediate indication can represent a weighting of the first compatibility indicator and the second compatibility indicator.

In some embodiments, the validation system 106 can generate a graphical user interface based on the analysis of the first compatibility indicator and/or the second compatibility indicator. For example, the validation system 106 can generate a graphical user interface that includes a visual representation of the first compatibility indicator and/or the second compatibility indicator. This visual representation can include a numeric or graphical representation indicating a degree to which one or more of the datasets obtained from the training database 114 are or are not compatible with the machine learning models 112 and/or the training objectives described herein. Additionally, or alternatively, the validation system 106 can generate the graphical user interface to indicate the intermediate indication. This can include updating or generating the graphical user interface to include a numeric or graphical representation indicating the degree to which the dataset is compatible with one or more of the machine learning models 112 or one or more of the training objectives described herein based on a comparison, such as a weighted comparison, of the first compatibility indicator and the second compatibility indicator. The validation system 106 can then provide data associated with the graphical user interface to the client device 108 to cause the client device to generate and display the graphical user interface using a display device thereof. As described in some examples, the client device 108 can then receive input from a user controlling the client device to control the model training system 110 when training the machine learning models 112 (or forgoing training the machine learning models 112) using some or all of the datasets obtained from the training database 114.

In some embodiments, the validation system 106 can provide a final indication to control operation of the model training system 110 involved in training and/or updating the one or more parameters of the machine learning models 112. For example, the validation system 106 can determine whether or not one or more of the machine learning models 112 should be trained using the datasets obtained from the training database 114 based on the intermediate indication. In this example, the validation system 106 can provide a final indication that includes a binary indication of whether or not one or more of the machine learning models 112 should be trained by the model training system 110 using the one or more datasets. The final indication can cause the network component 102 and/or the model training system 110 to either transfer/not transfer and/or train/update or not train/update one or more of the machine learning models 112 using some or all of the datasets obtained from the training database 114.

In one example, the validation system 106 can determine that one or more of the datasets from the training database 114 do not satisfy one or more training thresholds that are established for respective compatibility indicators or combinations thereof and can, in response, provide a final indication to one or more components of the network component 102 or to the model training system 110 not to train and/or update one or more of the machine learning models 112 using the datasets from the training database 114. In this example, the training threshold can be indicative of a degree that must be satisfied by one or more of the datasets. For example, where the datasets are identified as being not compatible with one or more of the machine learning models 112 based on a comparison of the first compatibility indicator to a training threshold, the validation system 106 can provide a final indication to alert the model training system 110 or the network component 102 that one or more of the datasets are not compatible with the machine learning models 112. Similarly, where the datasets are identified as including data that does not satisfy one or more operational parameters and as a result are not relevant (temporally, etc.), the validation system 106 can provide a final indication to alert the model training system 110 or the network component 102 that one or more of the datasets are not compatible with the training objectives involved in training and/or updating the machine learning models 112.

In some embodiments, the network component 102 can determine that a subset of network operations represented by one or more of the datasets obtained from the training database 114 satisfy one or more of the operational parameter thresholds described herein and can generate an indication of the network operations that satisfy the operational parameter thresholds. For example, the network component 102 can first filter the datasets obtained from the training database 114 based on criteria established by the operational parameters associated with the machine learning models 112 and/or the training objectives for training the machine learning models 112. In this example, the network component 102 can filter the datasets such that network operations that satisfy the operational parameters or training objectives are identified and/or removed from the datasets obtained from the training database 114. The network component 102 can then provide the third indicator to control operation of the model training system 110 or the network component 102 based on executing operations to filter the datasets obtained by the training database 114. For example, the network component 102 can generate a graphical user interface (e.g., at the client device 108) that indicates the network operations that were filtered from the datasets obtained from the training database 114. In another example, the network component 102 can generate a graphical user interface (e.g., at the client device 108) that indicates that one or more datasets obtained from the training database 114 are not compatible with the machine learning models 112 to be trained by the model training system 110. In this example, the network component 102 can provide an indication to control operation of the model training system or the network component 102 such that either the datasets are not provided by the network component 102 to the model training system 110 or that the model training system 110 does not train and/or update the machine learning models 112 using the identified datasets.

In some embodiments, the network component 102 can receive an indication of one or more updates to be made to the datasets obtained from the training database 114 and can execute operations to update the datasets before providing the datasets to the model training system 110 to be used when training the machine learning models 112. For example, the network component 102 can receive an indication from the client device 108 (e.g., based on user input received at the client device 108) indicating that one or more updates are to be made to the datasets. These updates can include adding data to one or more portions of the datasets, removing data from one or more portions of the datasets, etc. The network component 102 can then execute one or more operations to perform the one or more updates to the datasets obtained from the training database 114 in accordance with the updates indicated by the client device 108 to improve the compatibility of the datasets with the machine learning models 112. In another example, the network component 102 can determine one or more updates to be made based on one or more components of the network component 102 determining that the datasets or portions thereof are not compatible or are not completely compatible with the machine learning models 112 or the training objectives for training and/or updating the machine learning models 112. The network component can then execute operations to perform the one or more updates to improve the compatibility of the datasets obtained from the training database 114. These operations can include removing portions of the datasets corresponding to network operations that are not compatible with the training objectives described herein. In these examples, the network component 102 can then provide the datasets to the model training system 110 to cause the model training system to train and/or update the machine learning models 112 using the updated datasets.

In some embodiments, the model training system 110 can train one or more of the machine learning models 112 based on indications received from the network component 102 or datasets obtained from the network component 102. For example, the network component 102 can identify datasets or portions thereof that are, or are not, compatible with the machine learning models 112 and/or the training objectives for training the machine learning models 112. The network component 102 can then provide indications to the model training system 110 and/or the datasets that are at least in part compatible with the machine learning models 112 to the model training system 110. This can cause the model training system 110 to execute one or more operations to train and/or update one or more of the machine learning models 112. Alternatively, the model training system 110 can configure a direct communication connection with the training database 114 and can selectively obtain datasets from the training database 114 based on the indications provided by the network component 102. This can allow the model training system 110 to obtain datasets that are at least in part compatible with the machine learning models 112 and/or the training objectives described herein.

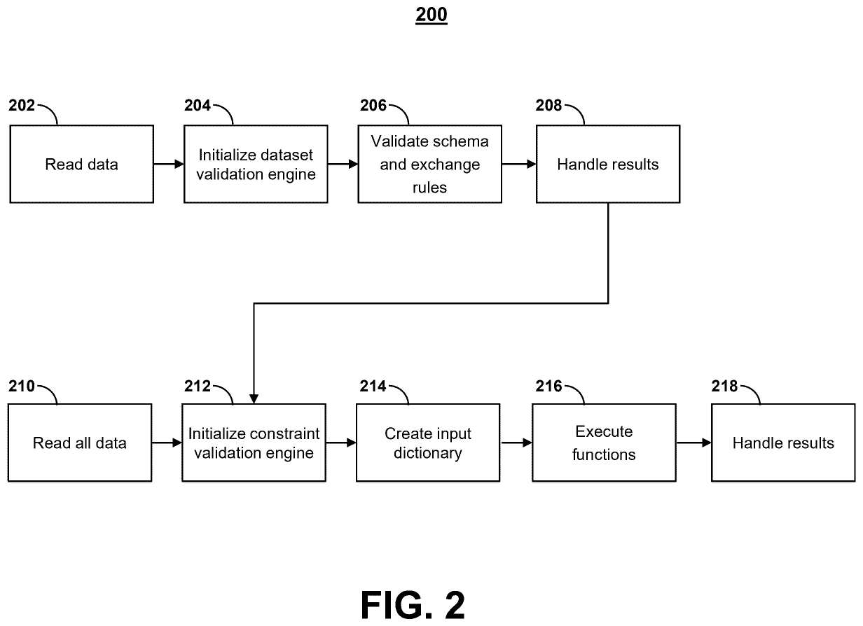

FIG. 2 shows a flow diagram of a process 200 for confirming data integrity of a dataset representing a plurality of network operations to be executed by a model, in accordance with one or more embodiments. In some embodiments, one or more operations described herein with respect to process 200 can be implemented by one or more devices that are the same as, or similar to, the those illustrated in the environment 100 of FIG. 1. For example, one or more of the operations described herein can be performed by a network component that is the same as, or similar to, the network component 102 of FIG. 1. In examples, one or more of the operations described herein can be performed by other components operating independent of or in coordination with the network component, such as a client device, a model training system, and/or a training database that are the same as, or similar to, the client device 108, the model training system 110, and/or the training database 114 of FIG. 1.

At 202, a network component can read data from a source such as metadata from a training database describing one or more structural aspects of the datasets stored by the training database. The network component can process the incoming data streams (e.g., the inbound metadata associated with network operations such as payment transactions). The data streams can receive data in a variety of data formats (e.g., JSON, XML). Based on this approach, the network component can determine that all relevant datasets are obtained before analysis using a dataset validation engine.

At 204, the network component can initialize a dataset validation engine at 204 (which can be the same as, or similar to, at least a portion of the compatibility determination system 104 of FIG. 1). In this example, the network component can configure one or more components (e.g., validation algorithms, data integrity checks) to validate incoming datasets. In examples, the dataset validation engine can check for data integrity (e.g., completeness, accuracy) and consistency (e.g., format adherence, logical coherence), confirming whether the datasets meet predefined standards.

At 206, the network component can validate a schema and exchange rules based on an output of the dataset validation engine. For example, the network component can verify that the data schema (e.g., database schema, XML schema) matches an expected structure and rules (e.g., data exchange protocols, validation rules). The network component can cross-check the schema against predefined exchange rules (e.g., API specifications, data sharing agreements) to confirm compatibility. Based on this validation, the network component can determine whether the data is appropriate for further processing.

At 208, the network component can handle the results generated by the network component and validate the schema and exchange rules to determine whether the data obtained is appropriate for further processing. For example, where at least a portion of the dataset satisfies at least a portion of the schema and/or exchange rules, the network component can proceed to 212 and further process the datasets. Alternatively, where at least a portion of the datasets do not satisfy at least the portion of the schema or the exchange rules, the network component can forego proceeding to 210.

At 210, the network component can read and obtain the data stored in the datasets representing the network operations identified as being usable to train and/or update one or more machine learning models. This can include reading the data from the database that is stored in various formats (e.g., SQL, NoSQL). The network component can handle different database management systems (e.g., MySQL, MongoDB), ensuring that relevant data is accessed.

At 212, the network component can initialize a constraint validation engine (e.g., which may be the same as, or similar to, at least a portion of the compatibility determination system 104 of FIG. 1). The network component can configure one or more components (e.g., validation rules, constraint checks) to validate incoming data. In certain scenarios, the compatibility and performance of a machine learning model can be evaluated by analyzing the data itself to determine whether it is compatible with the machine learning models to be trained and/or the training objectives for training the machine learning models. For example, a dataset can be established through processes such as data aggregation, where relevant data is collected and combined from various sources. Once prepared, the dataset (e.g., the underlying elements represented by the data in the dataset) can be analyzed to assess compatibility with the machine learning models. In examples, this analysis can include examining the underlying representations associated with the data, such as aspects about the network operations represented by the data. By determining the compatibility of the data before training, systems can minimize unnecessary computational overhead and resource allocation, leading to more efficient and effective model training.

At 214, the network component can create an input dictionary. In this example, the network component can organize the data into a structured format (e.g., key-value pairs, JSON objects) to index the data to be accessed and manipulated by one or more systems involved in training machine learning models using the data. The input dictionary can include various data attributes (e.g., user information, transaction details). Based on this input dictionary, the network component can allow for efficient data processing and analysis by downstream systems such as, for example, a model training system.

At 216, the network component can execute functions to train machine learning models using the data obtained from the training datasets. For example, the network component can execute various machine learning models (e.g., artificial neural networks and so on) using the training data, and iteratively update the weights of the machine learning models until achieving convergence.

At 218, the network component can then handle results by outputting the results of the training. In this example, the network component can process the machine learning models (e.g., after training and/or updating) to generate insights regarding the configuration of the machine learning models (e.g., predictions, classifications). In examples, the network component can present the results in various formats (e.g., reports, visualizations), allowing for user interpretability. Alternatively, if the network component determines that the data obtained from the training database is not compatible or otherwise suitable for training one or more of the machine learning models, the network component can handle the results by outputting an indication that the data obtained will not be used, or is not otherwise suitable to be used, to train the machine learning models described herein.

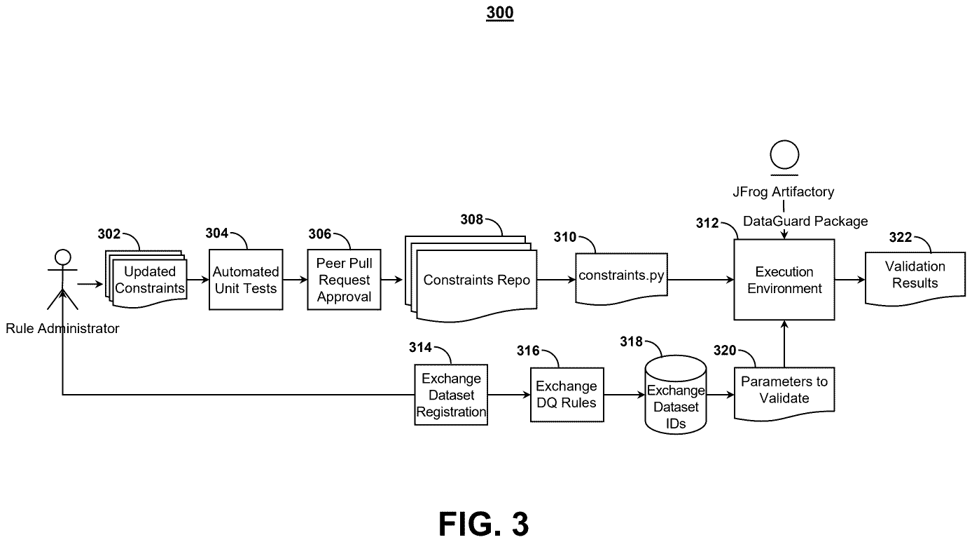

FIG. 3 shows an implementation diagram of a process 300 for confirming data integrity of a dataset representing a plurality of network operations to be executed by a model, in accordance with one or more embodiments. In some embodiments, one or more operations described herein with respect to process 300 can be implemented by one or more devices that are the same as, or similar to, those illustrated in the environment 100 of FIG. 1. For example, one or more of the operations described herein can be performed by a network component that is the same as, or similar to, the network component 102 of FIG. 1. In examples, one or more of the operations described herein can be performed by other components operating independent of or in coordination with the network component, such as a client device, a model training system, and/or a training database that are the same as, or similar to, the client device 108, the model training system 110, and/or the training database 114 of FIG. 1.

At 302, the network component (e.g., a server, router, etc.) can obtain updated constraints (e.g., data size limits, database schemas) representing parameters for data and/or datasets to be obtained and used by an execution environment described below when training one or more machine learning models. These updated constraints can be based on existing or new constraints for data to be used when training and/or updating one or more machine learning models using data obtained by the network component from one or more datasets (e.g., customer data, transaction records) accessible by the network component. These constraints can be used to confirm that the machine learning models are trained and/or updated using data obtained by the network component that satisfies one or more specified parameters.

At 304, the network component can execute one or more updates to automated unit tests (e.g., data validation tests, performance tests) based on the updated constraints. The network component can execute automated unit tests to verify that the datasets (e.g., training data, test data) obtained by the network component meet the updated constraints.

At 306, the network component can generate a peer pull request approval (e.g., code review approval, merge request approval). This peer pull request approval can be based on the successful execution of unit tests based on the updated constraints. This approval can indicate confirmation to use one or more unit tests when analyzing datasets for training one or more machine learning models.

At 308, the network component can store the constraints stored in a constraint repository (e.g., a database, a configuration management system). These constraints can be configured to be retrieved based on specific queries (e.g., SQL queries, API requests). Accessing these constraints can be used to establish a system configuration for the execution environment when training one or more machine learning models.

At 310, the network component can obtain a constraint file (e.g., a JSON file, an XML file) prior to the execution of operations by an execution environment when training one or more machine learning models. This constraint file can contain detailed information about system limitations established by the updated constraints described above.

At 312, the network component can provide the constraint file to an execution environment. The network component can provide the constraint file to the execution environment to allow it to determine whether or not to execute one or more operations to train one or more machine learning models. The execution environment can then determine whether or not to proceed with training based on a comparison of the constraints outlined by the constraint file to data accessible by the execution environment. The execution environment can be the same as, or similar to, the model training system 110 of FIG. 1.

At 314, the network component can register with an exchange dataset (e.g., a data marketplace, a data sharing platform). This exchange dataset registration can be based on predefined protocols (e.g., authentication protocols, data exchange standards). Exchanging this registration can facilitate data management (e.g., data access control, data usage tracking).

At 316, the network component can exchange data quality (DQ) rules. These data quality rules can be based on internal standards, industry standards, etc. These rules can represent one or more parameters associated with the data to be obtained by the execution environment when training one or more machine learning models. These parameters can indicate values or ranges of values that are acceptable for one or more elements or entries in the data used to train the machine learning models, such as dates on which the data was generated, values represented by the data itself such as transaction values, etc.

At 318, the network component can obtain one or more dataset IDs from an index of dataset identifiers. These dataset IDs can be based on unique identifiers and can indicate one or more datasets that are to be obtained by the execution environment when training one or more machine learning models.

At 320, the network component can provide one or more parameters to use when validating the data obtained by the execution environment to train the one or more machine learning models. These parameters can be indicative of one or more values or ranges of values described with respect to 316 that can be compared to determine whether or not the data is suitable for training the machine learning models in the execution environment.

In examples where data obtained by the execution environment satisfies one or more constraints and/or parameters as described above, the network component can implement an execution environment to execute operations when training the one or more machine learning models. The constraints (from 310) and the parameters (from 320) can be used by the execution environment to determine whether the data obtained by the execution environment is compatible with the machine learning models to be trained. In examples where either the constraints or the parameters do not indicate that the data obtained by the execution environment is compatible with one or more of the machine learning models to be trained, the network component can forego training the one or more machine learning models. In either example, the network component at 322 can generate an output indicating one or more validation results. This can include an indication of whether or not the data obtained by the execution environment was suitable for training the one or more machine learning models and whether or not the data was used to train the one or more machine learning models.

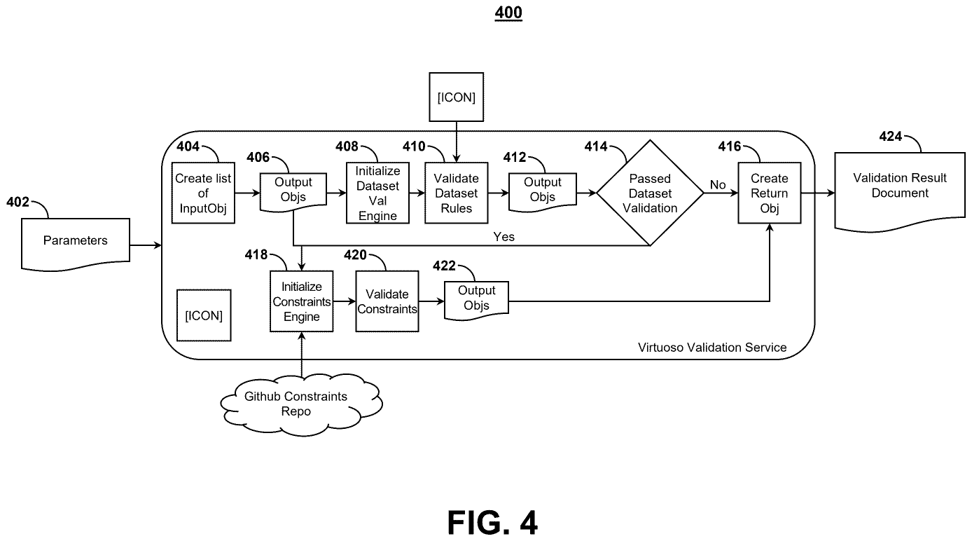

FIG. 4 shows an implementation diagram of a process 400 for confirming data integrity of a dataset representing a plurality of network operations to be executed by a model, in accordance with one or more embodiments. In some embodiments, one or more operations described herein with respect to process 400 can be implemented by one or more devices that are the same as, or similar to, those illustrated in the environment 100 of FIG. 1. For example, one or more of the operations described herein can be performed by a network component that is the same as, or similar to, the network component 102 of FIG. 1. In examples, one or more of the operations described herein can be performed by other components operating independent of or in coordination with the network component, such as a client device, a model training system, and/or a training database that are the same as, or similar to, the client device 108, the model training system 110, and/or the training database 114 of FIG. 1.

At 402, the network component can obtain parameters associated with datasets that can be used to train a machine learning model. For example, the network component can obtain the parameters to allow the network component to determine whether one or more datasets are properly configured for the training process based on the parameters. These parameters can include data types, ranges, and other relevant attributes related to the structure of the data included in datasets that are accessible by the network component.

At 404, the network component can create a list of input objects. In this context, the network component creating the list can compile all input objects involved, such as datasets accessible by the network component for training and/or updating one or more machine learning models. At 406, the network component can then obtain information about the input objects (e.g., metadata representing the structure of the input objects) from a data source such as a training database. In examples, this source may include a database, file, or other data repository.

At 408, the network component can initialize a database validation engine. For instance, the network component can initialize the database validation engine by configuring one or more operations to be executed when validating datasets within a database. This initialization process can involve configuring validation rules, establishing connections, and preparing the engine for operation.

At 410, the network component can obtain dataset rules to use when validating one or more datasets. For example, the network component can obtain the dataset rules to be used in conjunction with the dataset validation engine when confirming that one or more datasets meet required validation criteria before proceeding with training and/or updating one or more machine learning models. These rules can include data integrity checks, format validations, and other relevant constraints.

At 412, the network component can output objects. In this context, the network component can generate the outputs based on data processed by the dataset validation engine using the dataset rules. The outputs can indicate whether or not the datasets should be used when training and/or updating one or more machine learning models.

At 414, the network component can determine whether a given dataset satisfies requirements based on outputs from the database validation engine. In this context, the network component can evaluate the datasets based on the outputs of the validation engine. This evaluation may include checks for data consistency, completeness, and other relevant criteria. In examples where the network component determines the datasets are suitable for training one or more of the machine learning models, the network component can continue to 418. In other examples where the network component determines the datasets are not suitable for training one or more machine learning models based on the output of the dataset validation engine, the network component can forego permitting the datasets to be used when training the one or more machine learning models.

At 418, the network component can initialize a constraint engine. For instance, the network component initializes this constraint engine to create an environment for analyzing datasets used in training one or more machine learning models while enforcing constraints (e.g., business constraints). This initialization process may involve configuring constraint rules, establishing connections, and preparing the engine for operation. At 420, the network component can then determine (e.g., validate) whether data stored in datasets satisfies one or more constraints. In this context, the network component performing the validation can check the data against predefined business constraints. These constraints may include criteria that, when satisfied, establish temporal relevance, appropriate transaction value ranges, and other applicable business rules.

At 422, the network component can generate an output indicating portions of datasets that satisfy constraints. In this context, the network component can generate the outputs produced results based on validated data. These portions may include data entries that meet all specified constraints.

At 416, the network component can create a return object identifying and/or including portions of datasets that have passed both dataset validation and constraint validation processes. In this context, the network component responsible for creating return objects can compile validated data into a structured format. This return object may include metadata, data entries, and other relevant information.

At 424, the network component can generate an output summarizing results from training machine learning models. In this context, the network component tasked with generating such outputs produces a summary of training outcomes. This output may include performance metrics, model parameters, and other relevant details.

FIG. 5 shows illustrative components for a system used to confirm data integrity of a protected dataset representing a plurality of protected network operations to be executed by a classification model to update at least a portion of the classification model, in accordance with one or more embodiments. As shown in FIG. 5, system 500 can include mobile device 522 and user terminal 524. While shown as a smartphone and personal computer, respectively, in FIG. 5, it should be noted that mobile device 522 and user terminal 524 can be any computing device, including, but not limited to, a laptop computer, a tablet computer, a handheld computer, and other computer equipment (e.g., a server), including “smart,” wireless, wearable, and/or mobile devices. FIG. 5 also includes cloud components 510. Cloud components 510 can alternatively be any computing device as described above and can include any type of mobile terminal, fixed terminal, or other device. For example, cloud components 510 can be implemented as a cloud computing system and can feature one or more component devices. It should also be noted that system 500 is not limited to three devices. Users can, for instance, utilize one or more devices to interact with one another, one or more servers, or other components of system 500. It should be noted that, while one or more operations are described herein as being performed by particular components of system 500, these operations can, in some embodiments, be performed by other components of system 500. As an example, while one or more operations are described herein as being performed by components of mobile device 522, these operations can, in some embodiments, be performed by components of cloud components 510. In some embodiments, the various computers and systems described herein can include one or more computing devices that are programmed to perform the described functions. Additionally, or alternatively, multiple users can interact with system 500 and/or one or more components of system 500. For example, in one embodiment, a first user and a second user can interact with system 500 using two different components.

With respect to the components of mobile device 522, user terminal 524, and cloud components 510, each of these devices can receive content and data via input/output (hereinafter “I/O”) paths. Each of these devices can also include processors and/or control circuitry to send and receive commands, requests, and other suitable data using the I/O paths. The control circuitry can comprise any suitable processing, storage, and/or input/output circuitry. Each of these devices can also include a user input interface and/or user output interface (e.g., a display) for use in receiving and displaying data. For example, as shown in FIG. 5, both mobile device 522 and user terminal 524 include a display upon which to display data (e.g., conversational response, queries, and/or notifications).

Additionally, as mobile device 522 and user terminal 524 are shown as touchscreen smartphones, these displays also act as user input interfaces. It should be noted that in some embodiments, the devices can have neither user input interfaces nor displays and can instead receive and display content using another device (e.g., a dedicated display device such as a computer screen and/or a dedicated input device such as a remote control, mouse, voice input, etc.). Additionally, the devices in system 500 can run an application (or another suitable program). The application can cause the processors and/or control circuitry to perform operations related to generating dynamic conversational replies, queries, and/or notifications.

Each of these devices can also include electronic storage. The electronic storages can include non-transitory storage media that electronically store information. The electronic storage media of the electronic storages can include one or both of (i) system storage that is provided integrally (e.g., substantially non-removable) with servers or client devices, or (ii) removable storage that is removably connectable to the servers or client devices via, for example, a port (e.g., a USB port, a FireWire port, etc.) or a drive (e.g., a disk drive, etc.). The electronic storages can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages can include one or more virtual storage resources (e.g., cloud storage, a virtual private network, and/or other virtual storage resources). The electronic storages can store software algorithms, information determined by the processors, information obtained from servers, information obtained from client devices, or other information that enables the functionality as described herein.

FIG. 5 also includes communication paths 528, 530, and 532. Communication paths 528, 530, and 532 can include the Internet, a mobile phone network, a mobile voice, or data network (e.g., a 5G or LTE network), a cable network, a public switched telephone network, or other types of communications networks or combinations of communications networks. Communication paths 528, 530, and 532 can separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices can include additional communication paths linking a plurality of hardware, software, and/or firmware components operating together. For example, the computing devices can be implemented by a cloud of computing platforms operating together as the computing devices.

Cloud components 510 can include model 502, which can be a machine learning model, an artificial intelligence model, etc. (which can be referred to collectively as “models” herein). Model 502 can take inputs 504 and provide outputs 506. The inputs can include multiple datasets, such as a training dataset and a test dataset. Each of the plurality of datasets (e.g., inputs 504) can include data subsets related to user data, predicted forecasts and/or errors, and/or actual forecasts and/or errors. In some embodiments, outputs 506 can be fed back to model 502 as input to train the model 502 (e.g., alone or in conjunction with user indications of the accuracy of outputs 506, labels associated with the inputs, or with other reference feedback information). For example, the system can receive a first labeled feature input, wherein the first labeled feature input is labeled with a known prediction for the first labeled feature input. The system can then train the first machine learning model to classify the first labeled feature input with the known prediction (e.g., an action graph, a graph characteristic, a graph value, an objective, etc.).

In a variety of embodiments, model 502 can update its configurations (e.g., weights, biases, or other parameters) based on the assessment of its prediction (e.g., outputs 506) and reference feedback information (e.g., user indication of accuracy, reference labels, or other information). In a variety of embodiments, where model 502 is a neural network, connection weights can be adjusted to reconcile differences between the neural network's prediction and reference feedback. In a further use case, one or more neurons (or nodes) of the neural network can require that their respective errors be sent backward through the neural network to facilitate the update process (e.g., backpropagation of error). Updates to the connection weights can, for example, be reflective of the magnitude of error propagated backward after a forward pass has been completed. In this way, for example, the model 502 can be trained to generate better predictions.

In some embodiments, model 502 can include an artificial neural network. In such embodiments, model 502 can include an input layer and one or more hidden layers. Each neural unit of model 502 can be connected with many other neural units of model 502. Such connections can be enforcing or inhibitory in their effect on the activation state of connected neural units. In some embodiments, each individual neural unit can have a summation function that combines the values of all of its inputs. In some embodiments, each connection (or the neural unit itself) can have a threshold function such that the signal must surpass it before it propagates to other neural units. Model 502 can be self-learning and trained, rather than explicitly programmed, and can perform significantly better in certain areas of problem-solving as compared to traditional computer programs. During training, an output layer of model 502 can correspond to a classification of model 502, and an input known to correspond to that classification can be input into an input layer of model 502 during training. During testing, an input without a known classification can be input into the input layer, and a determined classification can be output.

In some embodiments, model 502 can include multiple layers (e.g., where a signal path traverses from front layers to back layers). In some embodiments, backpropagation techniques can be utilized by model 502, where forward stimulation is used to reset weights on the “front” neural units. In some embodiments, stimulation and inhibition for model 502 can be more free-flowing, with connections interacting in a more chaotic and complex fashion. During testing, an output layer of model 502 can indicate whether or not a given input corresponds to a classification of model 502 (e.g., an action graph, a graph characteristic, a graph value, an objective, etc.).

In some embodiments, the model (e.g., model 502) can automatically perform actions based on outputs 506. In some embodiments, the model (e.g., model 502) cannot perform any actions. The output of the model (e.g., model 502) can be used to generate a response in a user interface.

System 500 also includes API layer 550. API layer 550 can allow the system to generate summaries across different devices. In some embodiments, API layer 550 can be implemented on mobile device 522 or user terminal 524. Alternatively, or additionally, the API layer 550 can reside on one or more of the cloud components 510. API layer 550 (which can be a REST or Web services API layer) can provide a decoupled interface to data and/or functionality of one or more applications. API layer 550 can provide a common, language-agnostic way of interacting with an application. Web services APIs offer a well-defined contract, called WSDL, that describes the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services as well as for exchanging information with partners in B2B transactions.

API layer 550 can use various architectural arrangements. For example, system 500 can be partially based on API layer 550, such that there is strong adoption of SOAP and RESTful Web services, using resources like Service Repository and Developer Portal, but with low governance, standardization, and separation of concerns. Alternatively, system 500 can be fully based on API layer 550, such that separation of concerns between layers like API layer 550, services, and applications is in place.

In some embodiments, the system architecture can use a microservice approach. Such systems can use two types of layers: Front-End Layer and Back-End Layer, where microservices reside. In this kind of architecture, the role of the API layer 550 can provide integration between the Front-End and Back-End. In such cases, API layer 550 can use RESTful APIs (exposition to front-end or even communication between microservices). API layer 550 can use AMQP (e.g., Kafka, RabbitMQ, etc.). API layer 550 can use incipient usage of new communications protocols such as gRPC, Thrift, etc.

In some embodiments, the system architecture can use an open API approach. In such cases, API layer 550 can use commercial or open-source API Platforms and their modules. API layer 550 can use a developer portal. API layer 550 can use strong security constraints by applying WAF and DDoS protection, and API layer 550 can use RESTful APIs as a standard for external integration.

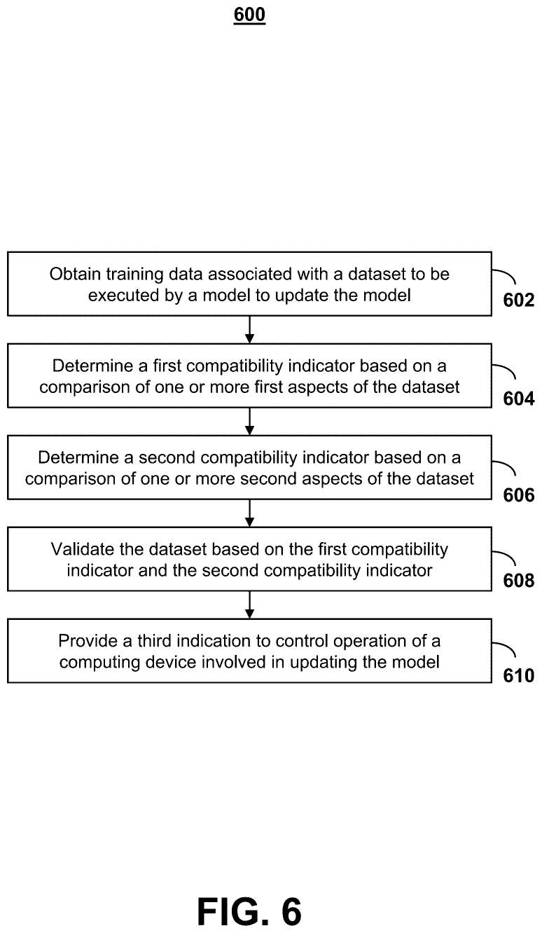

FIG. 6 shows a flowchart of the steps involved in a process 600 for confirming data integrity of a dataset representing a plurality of network operations to be executed by a model, in accordance with one or more embodiments. For example, a system that is the same as, or similar to, one or more of the systems and/or devices described with respect to FIG. 1, such as the network component 102 (or one or more components thereof), can implement some or all of the operations described with respect to process 600.

At operation 602, the process 600 can include obtaining training data associated with a dataset representing a plurality of protected network operations to be executed by a model to train and/or update one or more parameters of the model. For example, the network component can obtain the training data to confirm that the corresponding dataset is at least in part compatible with the model. In examples, the dataset can include a first set of network operations (e.g., protected network operations) that are compatible with the model and a second set of network operations that are at least in part not compatible with the model.

At operation 604, a first compatibility indicator can be determined based on a comparison of one or more first aspects of the dataset to first predetermined criteria. For example, the network component tasked with determining the first compatibility indicator can evaluate the dataset against specific criteria. As a result, the network component can determine the first compatibility indicator, where the first compatibility indicator identifies at least one network operation of the second set of protected network operations that is incompatible with the classification model.

At operation 606, a second compatibility indicator can be determined based on a comparison of one or more second aspects of the dataset to second predetermined criteria. In this example, the network component responsible for determining the second compatibility indicator can assess the dataset against another set of criteria. In examples, the second compatibility indicator can indicate that at least one network operation of the second set of protected network operations is not compatible with the classification model.

At operation 608, the dataset can be validated based on the first compatibility indicator and the second compatibility indicator to determine an intermediate indication of at least a degree to which the dataset is compatible with one or more models to be trained using the dataset. In this example, the network component tasked with validating the dataset uses the compatibility indicators to assess the overall compatibility. In examples, this validation can provide an intermediate indication of the dataset's compatibility with the model.

At operation 610, a third indicator can be provided to control operation of a computing device involved in training and/or updating the mode. For example, the network component can provide a third indicator to allow or prevent a computing device such as a model training system from executing operations to update the one or more parameters based on the intermediate indication. In this example, the network component responsible for providing the third indicator can confirm that the computing device does not proceed with updates if the dataset is not sufficiently compatible. In examples, this third indicator can act as a safeguard to maintain the integrity of the model.

Some embodiments of the present disclosure are described in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

An Application-Specific Integrated Circuit (ASIC) is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model's computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects that can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC's capabilities, reducing inefficiencies, and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims that follow. Furthermore, it should be noted that the features and limitations described in any one embodiment can be applied to any embodiment herein, and flowcharts or examples relating to one embodiment can be combined with any other embodiment in a suitable manner, done in different orders, or done in parallel. In addition, the systems and methods described herein can be performed in real time. It should also be noted that the systems and/or methods described above can be applied to, or used in accordance with, other systems and/or methods.

The present techniques will be better understood with reference to the following enumerated embodiments:
1. Methods for establishing a test environment that is cross-compatible with a plurality of client devices.
2. The method of any one of the preceding embodiments, the method comprising: obtaining training data associated with a dataset to be executed by a classification model to update one or more parameters of the classification model; determining a first compatibility indicator based on a comparison of one or more first aspects of the dataset to first predetermined criteria, the first compatibility indicator associated with a first indication of whether the dataset is compatible with the classification model; determining a second compatibility indicator based on a comparison of one or more second aspects of the dataset to second predetermined criteria, the second compatibility indicator associated with a second indication of whether the dataset is compatible with the classification model; validating, based on the first compatibility indicator and the second compatibility indicator, the dataset to determine an intermediate indication of at least a degree to which the dataset is compatible with the classification model; and providing a third indicator to control operation of a computing device involved in updating the one or more parameters of the classification model based on the intermediate indication.
3. The method of any one of the preceding embodiments, wherein obtaining the training data comprises: obtaining an indication that the training data is involved in execution of the classification model to update the one or more parameters of the classification model, the method further comprising: determining the first predetermined criteria based on one or more parameter types associated with the one or more parameters of the classification model.
4. The method of any one of the preceding embodiments, wherein determining the first compatibility indicator comprises: determining that one or more parameter types associated with the one or more parameters of the classification model are represented by the dataset; and determining the first compatibility indicator in response to determining that the one or more parameter types are represented, the first compatibility indicator representing that the dataset is at least in part compatible with the classification model.
5. The method of any one of the preceding embodiments, wherein determining the first compatibility indicator comprises: determining that one or more parameter types associated with the one or more parameters of the classification model are not represented by the dataset; and determining the first compatibility indicator in response to determining that the one or more parameter types are represented, the first compatibility indicator representing that the dataset is at least in part not compatible with the classification model.
6. The method of any one of the preceding embodiments, wherein determining the first compatibility indicator comprises: determining that the dataset comprises data associated with an additional parameter type that is not included in one or more parameter types of the one or more parameters of the classification model; and determining the first compatibility indicator in response to determining that the dataset comprises the data associated with the additional parameter type, the first compatibility indicator representing that the dataset comprises additional data that is not required to update the one or more parameters of the classification model.
7. The method of any one of the preceding embodiments, wherein determining the first compatibility indicator comprises: determining a first efficiency value representing a degree of efficiency loss at least in part attributable to the additional data of the dataset; and determining the first compatibility indicator based on the first efficiency value, the first compatibility indicator.
8. The method of any one of the preceding embodiments, wherein determining the second compatibility indicator comprises: obtaining an indication that the training data is involved in execution of the classification model to update the one or more parameters of the classification model, the method further comprising: determining the second predetermined criteria based on the classification model and one or more operational parameters associated with network operations in the dataset.
9. The method of any one of the preceding embodiments, wherein determining the second compatibility indicator comprises: determining one or more types associated with network operations in the dataset; determining one or more network operation parameters associated with the one or more types associated with the network operations are included in one or more operational parameters; comparing the one or more network operation parameters to values associated with the network operations in the dataset; and determining the second compatibility indicator based on comparing the one or more network operation parameters to the values associated with the network operations in the dataset, the second compatibility indicator representing a degree to which the dataset is at least in part compatible with the one or more operational parameters.
10. The method of any one of the preceding embodiments, wherein providing a third indicator to control operation of a computing device involved in updating the one or more parameters of the classification model comprises: generating a graphical user interface based on the second compatibility indicator, the graphical user interface visually representing the degree to which the dataset is at least in part compatible with the one or more operational parameters.
11. The method of any one of the preceding embodiments, further comprising: determining a subset of network operations represented by the dataset that satisfy one or more operational parameter thresholds; and generating an indication of the subset of network operations that satisfy the one or more operational parameter thresholds, wherein providing the third indicator to control operation of the computing device involved in updating the one or more parameters of the classification model comprises: generating a graphical user interface based on the indication of the subset of network operations, and providing the third indicator comprising the graphical user interface to computing device.
12. The method of any one of the preceding embodiments, further comprising: receiving, based on input at the computing device, an indication of one or more updates to be made to the dataset; and executing the one or more updates to cause the training data in accordance with the one or more updates to be made to the dataset.
13. The method of any one of the preceding embodiments, further comprising: in response to determining that the second compatibility indicator satisfies one or more operational parameter thresholds, executing one or more operations to update the training data to remove one or more network operations from the dataset.
14. The method of any one of the preceding embodiments, wherein the computing device comprises a first computing device, wherein determining the first compatibility indicator and the second compatibility indicator comprises: obtaining, at a second computing device, a database structure and attribute data associated with the dataset at the computing device, and determining, at the second computing device, the first compatibility indicator and the second compatibility indicator based on the database structure and the attribute data.
15. The method of any one of the preceding embodiments, wherein providing the third indicator to control operation of the computing device comprises: providing an indication to the computing device to update or to not update the classification model based on the intermediate indication.
16. One or more non-transitory, computer-readable mediums storing instructions recorded thereon that, when executed by a data processing apparatus, cause the data processing apparatus to perform operations comprising those of any of embodiments 1-15.
17. A system comprising one or more processors and memory storing instructions that, when executed by the processors, cause the processors to effectuate operations comprising those of any of embodiments 1-15.
18. A system comprising means for performing any of embodiments 1-15.

What is claimed is:

1. A system for confirming data integrity of a protected dataset representing a plurality of protected network operations to be executed by a classification model to update at least a portion of the classification model, the system comprising:
one or more processors configured to:
obtaining training data associated with a dataset representing a plurality of protected network operations to be executed by a classification model to update one or more parameters of the classification model,
the dataset comprising a first set of protected network operations that are compatible with the classification model and a second set of protected network operations that are at least in part not compatible with the classification model;
determining a first compatibility indicator based on a comparison of one or more first aspects of the dataset to first predetermined criteria, the first compatibility indicator indicating that at least one network operation of the second set of protected network operations is not compatible with the classification model;
determining a second compatibility indicator based on a comparison of one or more second aspects of the dataset to second predetermined criteria, the second compatibility indicator indicating that at least one network operation of the second set of protected network operations is not compatible with the classification model;
validating, based on the first compatibility indicator and the second compatibility indicator, the dataset to determine an intermediate indication of at least a degree to which the dataset is compatible with the classification model; and
providing a third indicator to prevent a computing device from executing operations to update the one or more parameters based on the intermediate indication.

2. A method, comprising:
obtaining training data associated with a dataset to be executed by a classification model to update one or more parameters of the classification model;
determining a first compatibility indicator based on a comparison of one or more first aspects of the dataset to first predetermined criteria, the first compatibility indicator associated with a first indication of whether the dataset is compatible with the classification model;
determining a second compatibility indicator based on a comparison of one or more second aspects of the dataset to second predetermined criteria, the second compatibility indicator associated with a second indication of whether the dataset is compatible with the classification model;
validating, based on the first compatibility indicator and the second compatibility indicator, the dataset to determine an intermediate indication of at least a degree to which the dataset is compatible with the classification model; and
providing a third indicator to control operation of a computing device involved in updating the one or more parameters of the classification model based on the intermediate indication.

3. The method of claim 2, wherein obtaining the training data comprises:
obtaining an indication that the training data is involved in execution of the classification model to update the one or more parameters of the classification model, the method further comprising:
determining the first predetermined criteria based on one or more parameter types associated with the one or more parameters of the classification model.

4. The method of claim 2, wherein determining the first compatibility indicator comprises:
determining that one or more parameter types associated with the one or more parameters of the classification model are represented by the dataset; and
determining the first compatibility indicator in response to determining that the one or more parameter types are represented, the first compatibility indicator representing that the dataset is at least in part compatible with the classification model.

5. The method of claim 2, wherein determining the first compatibility indicator comprises:
determining that one or more parameter types associated with the one or more parameters of the classification model are not represented by the dataset; and
determining the first compatibility indicator in response to determining that the one or more parameter types are represented, the first compatibility indicator representing that the dataset is at least in part not compatible with the classification model.

6. The method of claim 2, wherein determining the first compatibility indicator comprises:
determining that the dataset comprises data associated with an additional parameter type that is not included in one or more parameter types of the one or more parameters of the classification model; and
determining the first compatibility indicator in response to determining that the dataset comprises the data associated with the additional parameter type, the first compatibility indicator representing that the dataset comprises additional data that is not required to update the one or more parameters of the classification model.

7. The method of claim 6, wherein determining the first compatibility indicator comprises:
determining a first efficiency value representing a degree of efficiency loss at least in part attributable to the additional data of the dataset; and
determining the first compatibility indicator based on the first efficiency value, the first compatibility indicator.

8. The method of claim 2, wherein determining the second compatibility indicator comprises:
obtaining an indication that the training data is involved in execution of the classification model to update the one or more parameters of the classification model, the method further comprising:
determining the second predetermined criteria based on the classification model and one or more operational parameters associated with network operations in the dataset.

9. The method of claim 2, wherein determining the second compatibility indicator comprises:
determining one or more types associated with network operations in the dataset;
determining one or more network operation parameters associated with the one or more types associated with the network operations are included in one or more operational parameters;
comparing the one or more network operation parameters to values associated with the network operations in the dataset; and
determining the second compatibility indicator based on comparing the one or more network operation parameters to the values associated with the network operations in the dataset, the second compatibility indicator representing a degree to which the dataset is at least in part compatible with the one or more operational parameters.

10. The method of claim 9, wherein providing a third indicator to control operation of a computing device involved in updating the one or more parameters of the classification model comprises:
generating a graphical user interface based on the second compatibility indicator, the graphical user interface visually representing the degree to which the dataset is at least in part compatible with the one or more operational parameters.

11. The method of claim 2, further comprising:
determining a subset of network operations represented by the dataset that satisfy one or more operational parameter thresholds; and
generating an indication of the subset of network operations that satisfy the one or more operational parameter thresholds,
wherein providing the third indicator to control operation of the computing device involved in updating the one or more parameters of the classification model comprises:
generating a graphical user interface based on the indication of the subset of network operations, and
providing the third indicator comprising the graphical user interface to computing device.

12. The method of claim 11, further comprising:
receiving, based on input at the computing device, an indication of one or more updates to be made to the dataset; and
executing the one or more updates to cause the training data in accordance with the one or more updates to be made to the dataset.

13. The method of claim 9, further comprising:
in response to determining that the second compatibility indicator satisfies one or more operational parameter thresholds, executing one or more operations to update the training data to remove one or more network operations from the dataset.

14. The method of claim 2, wherein the computing device comprises a first computing device,
wherein determining the first compatibility indicator and the second compatibility indicator comprises:
obtaining, at a second computing device, a database structure and attribute data associated with the dataset at the computing device, and
determining, at the second computing device, the first compatibility indicator and the second compatibility indicator based on the database structure and the attribute data.

15. The method of claim 2, wherein providing the third indicator to control operation of the computing device comprises:
providing an indication to the computing device to update or to not update the classification model based on the intermediate indication.

16. One or more non-transitory, computer-readable mediums comprising instructions that, when executed by one or more processors, cause the one or more processors to perform operations comprising:
obtaining training data associated with a dataset to be executed by a classification model to update one or more parameters of the classification model;
determining a first compatibility indicator based on a comparison of one or more first aspects of the dataset to first predetermined criteria, the first compatibility indicator associated with a first indication of whether the dataset is compatible with the classification model;
determining a second compatibility indicator based on a comparison of one or more second aspects of the dataset to second predetermined criteria, the second compatibility indicator associated with a second indication of whether the dataset is compatible with the classification model;
validating, based on the first compatibility indicator and the second compatibility indicator, the dataset to determine an intermediate indication of at least a degree to which the dataset is compatible with the classification model; and
providing a third indicator to control operation of a computing device involved in updating the one or more parameters of the classification model based on the intermediate indication.

17. The one or more non-transitory, computer-readable mediums of claim 16, wherein the instructions that cause the one or more processors to obtain the training data cause the one or more processors to:
obtain an indication that the training data is involved in execution of the classification model to update the one or more parameters of the classification model,
wherein the instructions further causing the one or more processors to:
determine the first predetermined criteria based on one or more parameter types associated with the one or more parameters of the classification model.

18. The one or more non-transitory, computer-readable mediums of claim 16, wherein the instructions that cause the one or more processors to determine the first compatibility indicator cause the one or more processors to:
determine that one or more parameter types associated with the one or more parameters of the classification model are represented by the dataset; and
determine the first compatibility indicator in response to determining that the one or more parameter types are represented, the first compatibility indicator representing that the dataset is at least in part compatible with the classification model.

19. The one or more non-transitory, computer-readable mediums of claim 16, wherein the instructions that cause the one or more processors to determine the first compatibility indicator cause the one or more processors to:
determine that one or more parameter types associated with the one or more parameters of the classification model are not represented by the dataset; and
determine the first compatibility indicator in response to determining that the one or more parameter types are represented, the first compatibility indicator representing that the dataset is at least in part not compatible with the classification model.

20. The one or more non-transitory, computer-readable mediums of claim 16, wherein instructions that cause the one or more processors to determine the first compatibility indicator cause the one or more processors to:
determine that the dataset comprises data associated with an additional parameter type that is not included in one or more parameter types of the one or more parameters of the classification model; and
determine the first compatibility indicator in response to determining that the dataset comprises the data associated with the additional parameter type, the first compatibility indicator representing that the dataset comprises additional data that is not required to update the one or more parameters of the classification model.
